(19) United States
(12) Patent Application Publication
(10) Pub. No.: US 2022/0159943 A1
(43) Pub. Date: May 26, 2022

(54) DEVICE FOR INTERFERING IN THE VISUAL NAVIGATION CAPABILITY OF ORGANISMS

(71) Applicant: Universität Innsbruck, lnnsbruck (AT)

(72) Inventor: Thorsten SCHWERTE, Innsbruck (AT)

(21) Appl. No.: 17/440,275

(22) PCT Filed: Mar. 15, 2020
(86) PCT No.: PCT/EP2020/057012

§ 371 Date: Sep. 17, 2021

(30) Foreign Application Priority Data
Mar. 18, 2019 (AT) A 50229/2019

(51) Int. Cl. A01M 29/10; G02B 27/12; A01M 1/04; A01M 1/02

(52) U.S. Cl. CPC A01M 29/10; G02B 27/126; G02B 26/0833; A01M 1/026; A01M 1/04

(57) ABSTRACT

A device for interfering with the optical navigation capability of an organism moving in air, comprising at least a detector, a projector and a control device connected to the detector and the projector, which is characterized in that using the detector a biological feature of an organism may be identified by way of at least a signal, wherein the control device then determines the trajectory of the organism and, in dependence on the species and trajectory of the organism, indicates a light pattern, which may be projected using the projector.

The present invention relates to a device for interfering with the optical navigation capability of organisms moving in air, comprising a detector and a projector. The invention further relates to a method for interfering with the optical navigation capability of organisms moving in air as well as a possibility to fix the organisms in their residing position by means of an inventive device.

### BACKGROUND OF THE INVENTION

Insects, in particular sanguivorous ones, are a major health hazard for human beings and animals all over the world. More than 500 million people are currently infected with diseases transmitted by mosquitos, with more than 3 million on an annual basis dying of the consequences thereof (World Health Organization, 2013). Furthermore, approximately 3.5 billion people—this is, nearly half of the world population—are exposed to the risk of being infected with a diseases transmitted by mosquitos. Global warming leads to tropical insect species migrating into non-tropical areas. Also local species have the potential to act as vectors for some of these diseases. For this reason, infections and deaths as a consequence will increase in the future if no appropriate measures are being taken.

There are three major reasons for the great danger of mosquitos. First of all, female mosquitos require a blood diet for the proper development of their eggs, with the evolution having rendered them with special mouth-parts, which enable to puncture the human skin. Secondly, some mosquitos are anthropophilic, meaning their preferred host is man. Thirdly, mosquitos carry a number of viruses or parasites within themselves, without being affected themselves. A rather cumbersome side-effect of their behaviour of searching for a host is that they will hinder human beings from falling asleep. In total, the mosquito is a highly effective and mobile vehicle for transmitting dangerous diseases with a significant danger for human health.

Currently, there are three mosquito control strategies:

1. Physical protection (barriers, nets . . . )

2. Chemical protection (repellents, attractants . . . )

3. Molecular-biological protection (sterile males . . . )

In the context of costs/benefits considerations, the various strategies have pros and cons. Whereas the third strategy is ethically rather controversial as molecular-biologically manipulated organisms are released into nature, the second strategy is locally highly effective but associated, however, with other dangers for the health of human beings.

It is an upcoming trend to develop physical pest control strategies, which use imaging systems (or other signal analyses) in order to recognize and monitor flying insects and to research the behaviour thereof. These methods use components such as microphones or other force perception sensors, light and light detectors. In some cases, there are used lasers to provide the mosquitos with critical energy amounts, without harming man. Many such optical systems consume a lot of energy, they are expensive, dangerous and often inflexible when attaching in the space to be protected.

In the US 2013/0167429 A1 there is disclosed a safe anti-mosquito laser, which is targeted via two reflective mirrors onto a mosquito, the position of which having been determined in advance by a sonar module.

The “photonic fence” disclosed in the U.S. Pat. No. 8,705,017 B2 allows, by way of an optical or acoustic detector and a processor, in addition to the detection of the insects also the identification of a biological feature (e.g. genus, sex). By way of this feature, there may be determined whether a targeted laser is to kill the insect or whether certain body parts/features are to be destroyed, respectively.

Similar to a light tent, the US 2012/0032096 discloses a device for creating a light barrier, which interferes with insects or pollen by abrupt change of the light intensity or renders these ineffective, respectively.

Such methods aim at increasing the capability to collect or selectively kill insects, which are of decisive importance for human health, instead of killing insects in general. The spectrum of the strategies ranges from improving existing physical methods to new pest control devices, which are sometimes inspired by technologies used for military surveillance, enemy identification and defence systems.

A further object of these mosquito repellent systems is to integrate all elements within a small housing in order to provide for a flexible attachment in the space to be protected. The closest prior art in regard to a device allowing for such a combination is disclosed in the US 2008/0051135 A1. Therein, by way of an optical beam divider and a projection optics, there is simultaneously projected light coming from an image creating device (e.g. LOCS) onto an external display and there is focused light coming from the outside onto a detector/a camera.

### BRIEF DESCRIPTION OF THE INVENTION

It is the object of the present invention to utilize the navigation capability of insets in order to provide for a mosquito control system as effective as possible, comprising a large protective surface and being variably usable, which may be realised without any complex physical installation.

This task is solved by a device for interfering with the optical navigation capability of an organism moving in air, comprising
at least a detector,
a projector and
a control device connected to the detector and the projector,

which is characterized in that the detector is configured to identify a biological feature of an organism by way of at least one signal, wherein the control device then determines the trajectory of the organism and, in dependence on the species and trajectory of the organism, indicates a light pattern, which may be projected using the projector.

In the present invention there is initially realized a detection and identification of flying insets in a monitored space. Subsequently, there is realized the projection of a land mark pattern in the monitored space, for example a bedroom, which deflects the flying insects on their flight to their preys. Optionally, there is furthermore realized a registration and localisation of the preys to be protected. In the present invention this is enabled among others by way of a combination of projection and detection optics. In this way, also the housing of an inventive device has sufficiently small dimensions such that it may be positioned by way of threads attached at the housing, for example, at a ceiling or dresser. The threads allow for the attachment of the housing at tripods.

Mosquitos (here Culex quinquefasciatus) have an unusual wing kinematics. Their long narrow wings will flap at notably high frequencies in regard to their size (>800 Hz) and at lower stroke amplitudes in comparison to other insect groups. This will facilitate the identification of mosquitos by means of acoustic (microphones) or pseudo-acoustic registration by way of optically functioning microphones. The maximum flight velocity is 4.3 km/h or 120 cm/s for West-African mosquitos (W. F. Snow, Ann. Trop. Med. Parasitol. 1980; 74: 239-242).

The mosquitos' search for preys is composed of at least four sensory inputs: The recognition of smells, carbon dioxide, heat and optical indicators. The behaviour of searching for preys is a complex process, and these animals seem to alternate, depending on the signal quality, between different navigation strategies, which in turn will be influenced by the distance to the prey and any possible obstacles in the surroundings. The independent and iterative nature of the sensory-motoric reflexes renders the strategy of searching for hosts of the mosquitos very robust. From observations and documents in the literature (F. van Breugel et. al., Curr. Biol. 2015; 25(16):2123-9) there is obvious that the animals navigate on the last metres towards the prey by means of “contact flight” and are subject during this phase to all disadvantages of the contact flight known from insects using orientation at optical land marks and celestial bodies.

The detector enables the registration of a biological feature of the organism and, depending thereon, the determination of the trajectory. Subsequently, the projector projects light patterns into the monitored space, which affect and interfere with the trajectory of the organisms. The device further enables a combination of the detection and projection optics.

The projector projects, according to the embodiment variant, either a static light pattern, which is preferably mechanically movable, whereby the organisms present in air will be deflected from a determined area within the monitored space in a targeted way, or an adaptive species-specific light pattern, whereby the trajectory of all organisms may be influenced at any locations within the monitored space.

Thereby, there may be determined in advance by the detector the position of a prey by way of certain features such as, for instance, the size and trajectory within the monitored space, in order to deflect the organism by means of the projections on the way to the prey in a targeted way.

In an embodiment variant of the present invention a detector is acoustic and comprises preferably at least one sensitive stereo microphone. An acoustic detector enables a frequency registration of the wing beats of the organisms and in this way by way of this species-specific feature a registration of the species spectrum.

In a further embodiment variant a detector is optical and comprises preferably at least one camera. Thereby, there may be generated by way of appearance, spectroscopy as well as pseudo-acoustic registration a species-specific finger print, and also biological features may be detected.

In this way, various insect species may thus, for example, be distinguished by way of the light reflected by these. Insects such as mosquitos are due to their small size especially prone to strong light sources, which is why they have special structures reflecting light such as, e.g., UV light. The ratio between absorption and reflection of various wavelengths may be of a decisive character for mosquitos or various insect species, respectively. A further differentiating feature of an insect having a very small mass is an inert flight dynamics, conditioned by the low Reynold's number (approx. 50-80). Furthermore, also the trajectory of an insect such as, e.g., the direction change frequency may be characteristic.

Another embodiment variant provides for the use of at least one optical detector, preferably a camera, as well as at least one acoustic detector, preferably a stereo microphone. Due to the combination of these detection possibilities there may be registered various specific features of the insects in order to guarantee a possibly exact species recognition.

When using an optical detector, the detection (imaging) and projection optics may be combined in a further aspect of the invention by way of an optical beam divider, and all components of the device may thus be integrated in a possibly small housing. The optical beam divider may be configured, for example, depending on the embodiment variant as a plate beam divider having two rectangular prisms or as a combination of mirrors and dichroic filters.

In a preferred embodiment variant, downstream of the optical beam divider, a beam path impacts on the image sensor, preferably a CMOS or CCD sensor having a remote IR cut-off filter, and the other beam path onto the “imaging surface” within the projector, preferably a DLP chip. Thereby, the DLP chip is in turn illuminated by a solid-state light source such as, e.g., LEDs or laser at various wave lengths (UV to remote IR). The CMOS or CCD sensor and the DLP chip have preferably the same projection dimensions, such that no further optics is required for scaling the projection paths.

In the embodiment variant above controlling the DLP chip as well as processing the image input signal of the CMOS or CCD sensor is realized via an image processing computer. There is preferred a single-board-system such as, for example, Raspberry Pi, such that this may also be integrated within the small housing.

Furthermore, the present invention solves the initially posed task by way of a method for interfering with the trajectory of at last one organism present in air using an embodiment variant of the device described above. The method thus comprises the following steps:

i) detection of a biological feature of the at least one organism,

ii) in dependence on the result in step i), detection of the trajectory of the at least one organism,

iii) interference with the trajectory of the at least one organism by means of projected light patterns,

iv) repetition of the steps i)-iii).

In step iii) of the method the trajectory of the at least one organism is interfered with depending on the embodiment variant either by static image pattern, which are preferably mechanically moved, or depending on the biological feature detected in advance by way of species-specific dynamic light patterns.

The movement of the light patterns is interpreted by the organism as a trajectory deviation and compensated for by the flight stabilizing circuits. By interference with its trajectory, the organism is mis-routed, which is why the prey will not be found. In one embodiment variant the “deviation” of the organism could also lure it into, for example, a vacuum-based trap to ultimately remove the organism from the monitored space.

In an embodiment variant the trajectory is detected until halt of the at least one organism, whereby immediately after the halt, there is projected a static light circle onto the organism and it is thus fixed in its residing position. By over-modulation of the visual system, hence, the perception of the organism is limited. Fixation by means of a light circle furthermore enables an easy detection of the organisms in order to optionally capture or destroy these, respectively.

The optimal destruction-free capture also provides for a matching of the type and flight dynamics in an already existing data base and furthermore provides for an adjustment of the dynamic light patterns via a learning algorithm in order to optimize the interference with the organisms.

In an embodiment variant there may be in addition displayed information on the number of the detected organisms present in air as well as the biological features thereof via an output device.

### DETAILED DESCRIPTION OF THE INVENTION

In order to more clearly illustrate the invention, the essential features are displayed by way of preferred embodiments of the inventive method and the inventive device in the following figures.

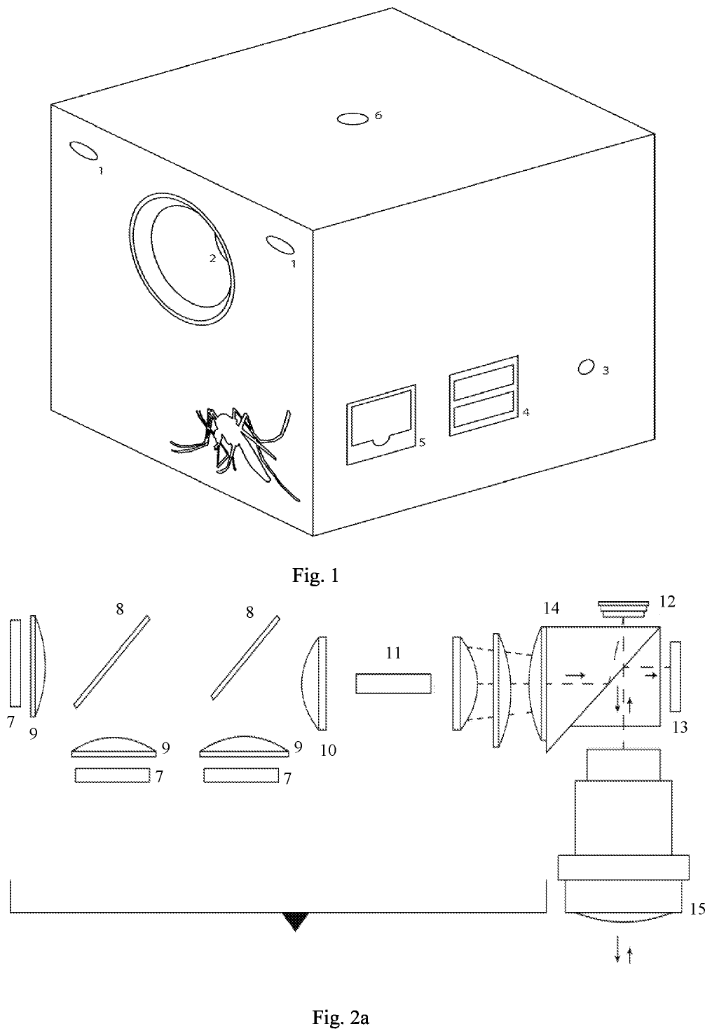

FIG. 1 shows the set-up of a housing of an inventive device.

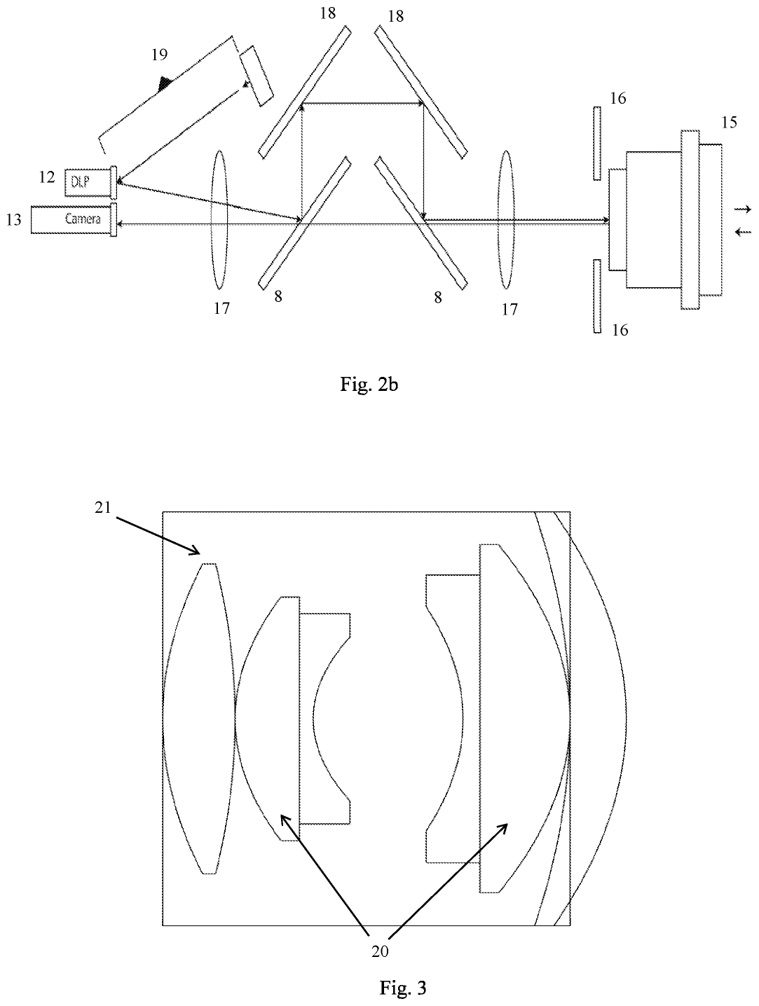

FIG. 2a shows a set-up of the projection and detection optics.

FIG. 2b shows an alternative set-up of the projection and detection optics.

FIG. 3 shows the set-up of the projection objective.

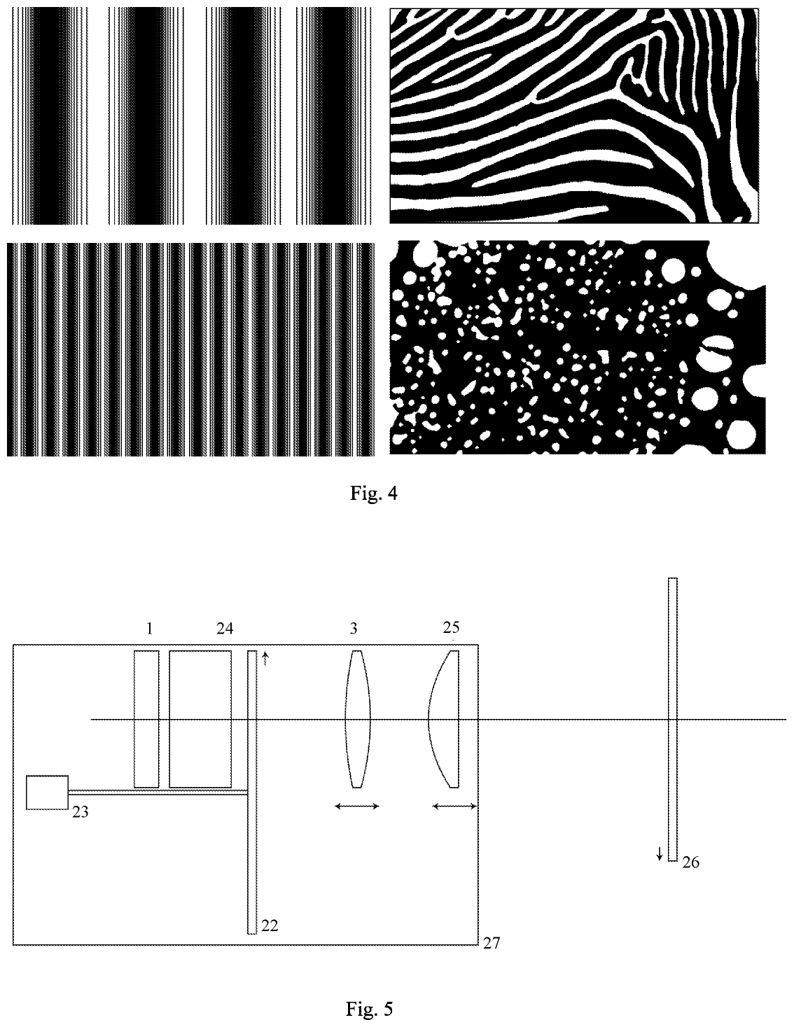

FIG. 4 shows four examples of freeze images of dynamic patterns.

FIG. 5 shows the set-up of a projector for static patterns.

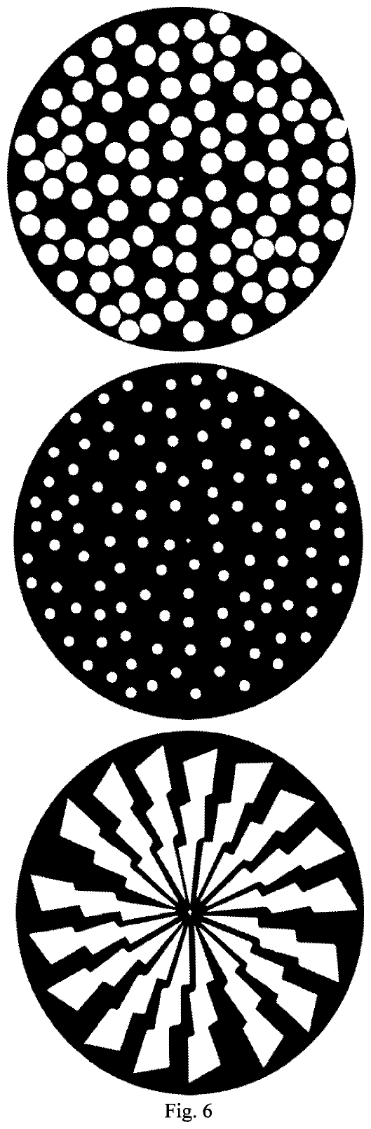

FIG. 6 shows three examples of different pattern disks for the projection of static image patterns.

In FIG. 1 there is shown the housing of an inventive device with the components attached to the housing. On the front surface of the housing there is situated the objective (2) as well as the microphones (1). On a lateral surface of the housing there are switch key PO/Reset (2), an USB I/O module and a voltage supply (4) as well as a network terminal (5). In addition, the device may have also an internal radio interface for connection with, for example, a WLAN. Furthermore, the housing has on two opposite surfaces a tripod thread (6), whereby attachment of the housing at a tripod is made possible. The compact housing may be attached at the ceiling as well as on a dresser by way of a common photo tripod.

When using an optical detector in a housing, the detection and projection optics may be combined in a beam path by way of an optical beam divider. FIG. 2a shows an exemplary embodiment of the optical set-up of the components of the optics used in the housing. The optical beam divider corresponds in FIG. 2a a TIR (Total Internal Reflection) prism (14), wherein one beam path ends on a CMOS- or CCD Sensor (13) and one beam path ends on a DLP (DMD) chip (12). The DLP chip (12) is illuminated by LED arrays (7) having different wavelengths per array via the DLP illumination path. By means of collimator lenses (9) arranged behind the LED arrays (7) and two dichroic filters (8) the light generated by the LED arrays (7) is focused in the DLP illumination path (characterized by the brace) and combined in a common light path. A condenser lens (10) focusses the filtered light further onto an optical integrator (11). Then the light enters the TIR prism (14), where it is reflected back to the DLP chip (12) and may again pass through the TIR prism (14) into the projection lens, which projects the desired pattern into the monitored space.

An alternative optical set-up provides for the division of the beam path only by way of mirrors and filters. As depicted in FIG. 2b, the DLP chip (12) and the CMOS or CCD sensor (13) are for this purpose arranged next to one another. The DLP chip (12) in turn is illuminated via the DLP illumination path (19) depicted in FIG. 2a. In the centre of the beam path, there are situated two mirrors (18) as well as two dichroic filters (8), which in this set-up assume the task of the TIR prism (14) of FIG. 2a. In addition, upstream and downstream of the mirrors (18) and filters (8) there is situated respectively one focusing lens (3). The light enters from the DLP chip (12) into the projection lens (15) via an aperture (16).

FIG. 3 shows a detailed view of a projection objective having a housing (21) and a lens assembly (20).

Examples of projected dynamic light patterns are depicted in FIG. 4. In this context, each of the four patterns corresponds to the frozen image of a dynamic pattern, which is projected into the monitored space.

A device according to the invention, however, does not only allow for the use of dynamic patterns, but also static patterns may be used and mechanically moved by way of the projector. FIG. 5 shows as an example an embodiment variant of such a projector. The Gobo projector depicted in FIG. 5 includes in its housing (27) at least one Gobo wheel (22), which may be rotated via a motor (23). The light in turn comes from an LED array (1) and is parallelized via a honeycomb light former (24) before impacting on the Gobo wheel (22). Behind the Gobo wheel (22) there is a focusing lens (3) as well as a zoom lens (25), which projects the pattern (26) of the Gobo wheel (22) into the monitored space. FIG. 6 shows three examples of patterns of the Gobo wheel.

In an embodiment variant the invention generates a moving pattern of, for example, dots, ovals, lines or circles using light of various wavelengths (e.g. LEDs or lasers of various wavelengths—UV to remote infrared). The movement of the light patterns is interpreted by the organism as a trajectory deviation and compensated for by the flight stabilizing circuits. By interfering with its trajectory, the organism is mis-routed, whereby the prey will not be found. In an embodiment variant the “deviation” of the organism may lure it into a vacuum-based trap in order to ultimately remove the animal from the monitored space. Alternatively, the system may also register and optically mark the flight end points of the organisms or over-modulate the organisms through light in a sensory way, respectively, in order to complicate an escape or to facilitate capturing and killing these. The invention shall be able to project species-specific patterns by means of imaging hardware (for example the DLP projector in FIGS. 2a and 2b) such that it can deflect various species. Further sensors (camera and sensitive stereo microphones) enable a coarse registration of the special spectrum by generating a species-specific “fingerprint” from appearance, flight dynamics, spectroscopy and acoustics. In the context of a connection of the devices at various locations (national and international), there may be enabled, for example, insect monitoring.

The possibility of connecting the devices allows for a sustainable data collection for distribution (monitoring), which improves the efficiency of the device and also enables prognoses and research by way of big data analysis.

A major advantage of the invention is that the device is comfortably and easily to attach, requires little space and does not constitute comfort limitation in regard to any other physical protective methods. It is free of any poisons and odours in comparison to chemical methods.

Adaption to and loss of effectiveness resulting therefrom are not to be expected. The typical market are all countries, in which there is present harassment and a health hazard by insects (in particular mosquitos), and thus is—on a global level—very large and steadily increasing due to global warming and the distribution of heat seeking insects resulting therefrom. Current studies in Tyrol show, for example, the appearance of the tiger mosquito, which has gained recognition due to the transfer of the Zika virus in the preceding years. Furthermore, the use of low-cost components and the operation using solar energy or a rechargeable battery attachable at the housing in a modular way, respectively, have been possible. For this reason, this device would be attractive also for outdoor and camping fans.

1. A device for interfering with the optical navigation capability of an organism moving in air, comprising
at least a detector,
a projector, and
a control device connected to the detector and the projector,
wherein the detector is configured to identify a biological feature of an organism by way of at least a signal, wherein the control device then determines the trajectory of the organism and, in dependence on the species and trajectory of the organism, indicates a light pattern, which may be projected using the projector.

2. A device according to claim 1, wherein at least one detector comprises an acoustic detector.

3. A device according to claim 1, wherein at least one detector comprises an optical detector.

4. A device according to claim 1, wherein the projector projects a static light pattern.

5. A device according to claim 1, wherein the projector projects a species-specific and adaptive light pattern.

6. A device according to claim 1, further comprising an optical beam divider.

7. A device according to claim 6, wherein downstream of the optical beam divider one beam path ends on the image sensor, and the other beam path ends on the imaging surface.

8. A method for interfering with the trajectory of at least one organism present in air using a device according to claim 1, comprises the following steps:
i) detecting a biological feature of the at least one organism,
ii) in dependence on the result in step i), detecting the trajectory of the at least one organism,
iii) interfering with the trajectory of the at least one organism by means of projected light patterns, and
iv) repeating steps i)-iii).

9. A method according to claim 8, wherein the trajectory of the at least one organism is interfered with by means of static light pattern projections.

10. A method according to claim 8, wherein the trajectory of the at least one organism is interfered with depending on the biological feature by way of species-specific dynamic light patterns.

11. A method according to claim 8, wherein the trajectory is detected until the halt of the at least one organism, wherein immediately after the halt there is projected a static light circle onto the organism and it is thus fixed in its residing position.

12. A method according to claim 8, wherein information on the number of the detected organisms present in air as well as of the biological features thereof are displayed via an output device.

13. A method according to claim 8, wherein the organisms are collected in a non-destructive way.

14. A device according to claim 2, wherein the acoustic detector comprises at least one sensitive stereo microphone.

15. A device according to claim 3, wherein the optical detector comprises at least one camera.

16. A device according to claim 6, wherein the projection and detection optics are combined by means of the optical beam divider.

17. A device according to claim 7, wherein the image sensor comprises a CMOS, and the imaging surface comprises a DLP chip.

18. A method according to claim 9, wherein the static light pattern projections are mechanically movable.
